(19) United States
(12) Patent Application Publication
(10) Pub. No.: US 2015/0057085 A1
(43) Pub. Date: Feb. 26, 2015

(54) NON-TRANSITORY COMPUTER-READABLE STORAGE MEDIUM, AND INFORMATION PROCESSING DEVICE

(71) Applicant: DeNA Co., Ltd., Tokyo (JP)

(72) Inventors: Keisuke TAGAWA, Tokyo (JP); Takashi KANAMORI, Tokyo (JP)

(73) Assignee: DeNA Co., Ltd., Tokyo (JP)

(21) Appl. No.: 14/019,990

(22) Filed: Sep. 6, 2013

(30) Foreign Application Priority Data
Aug. 20, 2013 (JP) 2013-170204

(51) Int. Cl. A63F 13/45; A63F 13/33

(52) U.S. Cl. CPC A63F 13/45; A63F 13/33
USPC 463/42

(57) ABSTRACT

A character provided to a player is actively used in a battle with an enemy character. A game program according to the present invention causes a computer to perform character provision processing of providing a character to a player, the character being selected, based on character information in which a plurality of characters are set, from among the plurality of characters; battle processing of automatically starting a battle with an enemy character, triggered by the provision of the character, and determining win or loss of the battle, the enemy character being an opponent of the provided character; and parameter change processing of changing a predetermined parameter set for the enemy character, using a predetermined parameter set for the provided character, during progress of the battle.

### FIELD OF THE INVENTION

The present invention relates to a game program, and an information processing device.

### DESCRIPTION OF THE RELATED ART

There is known a game program that causes a computer to perform provision processing of providing a character to a player; and battle processing of determining win or loss of a battle with an enemy character which is an opponent of the provided character (e.g., JP 5086491 B1).

### SUMMARY OF THE INVENTION

In such a game program, for example, when a character with low rarity or a character with small parameter values is provided to a player, the character may be sold as it is or may be combined and thus may not be used at all in a battle with an enemy character.

The present invention is made in view of such circumstances, and an object of the present invention is to actively use a character provided to a player, in a battle with an enemy character.

The main aspect of the present invention to solve the above-described problem is directed to a non-transitory computer-readable storage medium that causes a computer to perform: character provision processing of providing a character to a player, the character being selected, based on character information in which a plurality of characters are set, from among the plurality of characters; battle processing of automatically starting a battle with an enemy character, triggered by the provision of the character, and determining win or loss of the battle, the enemy character being an opponent of the provided character; and parameter change processing of changing a predetermined parameter set for the enemy character, using a predetermined parameter set for the provided character, during progress of the battle.

Other characteristics of the present invention will become clear from the description of the present specification and the appended drawings.

According to the present invention, a character provided to a player can be actively used in a battle with an enemy character.

### BRIEF DESCRIPTION OF THE DRAWINGS

FIG. 1 is a diagram illustrating an overall configuration example of a game system;

FIG. 2 is a block diagram illustrating a functional configuration of a server device;

FIG. 3 is a block diagram illustrating a functional configuration of a player terminal;

FIG. 4 is a diagram illustrating an example of a data structure of character information;

FIG. 5 is a diagram illustrating an example of a data structure of item information;

FIG. 6 is a diagram illustrating an example of a data structure of player information;

FIG. 7 is a diagram illustrating an example of a data structure of possessed character information;

FIG. 8 is a diagram illustrating an example of a data structure of possessed item information;

FIG. 9 is a diagram illustrating an example of a data structure of battle deck information;

FIG. 10 is a diagram illustrating an example of a data structure of enemy character information;

FIG. 11 is a diagram illustrating an example of a data structure of enemy deck information;

FIG. 12 is a diagram illustrating an example of a data structure of reward information;

FIG. 13 is a flowchart for describing an example of the operation of the game system;

FIG. 14 is a diagram illustrating an example of a game screen displayed at the start of a game;

FIG. 15 is a diagram illustrating an example of a game screen displayed during the progress of the game; and

FIG. 16 is a diagram illustrating an example of a game screen displayed when the game is over.

### DETAILED DESCRIPTION OF THE INVENTION

At least the following matters will become clear according to the description of the present specification and the appended drawings.

Specifically, there is provided a game program that causes a computer to perform: character provision processing of providing a character to a player, the character being selected, based on character information in which a plurality of characters are set, from among the plurality of characters; battle processing of automatically starting a battle with an enemy character, triggered by the provision of the character, and determining win or loss of the battle, the enemy character being an opponent of the provided character; and parameter change processing of changing a predetermined parameter set for the enemy character, using a predetermined parameter set for the provided character, during progress of the battle.

According to such a game program, when a character is provided to the player, a battle with an enemy character automatically starts. At the battle, a parameter of the provided character is used. Hence, the character provided to the player is actively used in a battle with an enemy character.

In addition, in the character provision processing, at least two or more characters selected from among the plurality of characters based on the character information may be provided to the player, the game program may cause the computer to perform player deck organization processing of automatically organizing a player deck independent of an operation of the player, upon starting the battle with the enemy character, the player deck composed of only the at least two or more provided characters, and in the battle processing, win or loss of a battle between each of the characters composing the organized player deck and the enemy character may be determined.

According to such a game program, at the start of a battle, characters provided to the player are used as they are to organize a player deck. Hence, the characters provided to the player can be more actively used.

In addition, the game program may cause the computer to perform enemy deck organization processing of selecting, based on enemy character information in which a plurality of enemy characters are set, at least two or more enemy characters from among the plurality of enemy characters, and organizing an enemy deck composed of the at least two or more selected enemy characters, and in the battle processing, win or loss of a battle between each of the enemy characters composing the organized enemy deck and each of the characters composing the organized player deck may be determined.

According to such a game program, to defeat all enemy characters, the characters provided to the player are more actively used.

In addition, the game program may cause the computer to perform reward provision processing of providing a reward to the player when loss of the enemy character has been determined, the reward being selected, based on reward information in which a plurality of rewards are set, from among the plurality of rewards.

According to such a game program, when the player wins a battle with an enemy character, a reward is provided to the player. Thus, the player's sense of anticipation can be increased.

Then, there is provided an information processing device including: a character provision unit that provides a character to a player, the character being selected, based on character information in which a plurality of characters are set, from among the plurality of characters; a battle processing unit that automatically starts a battle with an enemy character, triggered by the provision of the character, and determines win or loss of the battle, the enemy character being an opponent of the provided character; and a parameter change processing unit that changes a predetermined parameter set for the enemy character, using a predetermined parameter set for the provided character, during progress of the battle.

According to such an information processing device, in a battle with an enemy character, a character provided to the player can be actively used.

### Embodiments

### Configuration of Game System 1

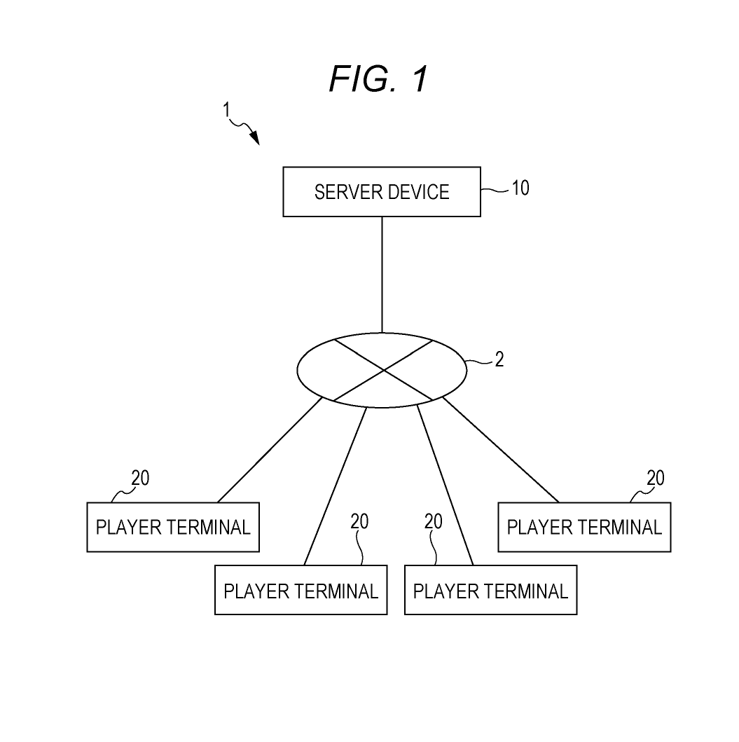

FIG. 1 is a diagram illustrating an example of an overall configuration of a game system 1 according to the present embodiment. The game system 1 provides a player with various services related to a game through a network 2 (for example, the Internet and the like), and includes a server device 10 and a plurality of player terminals 20.

### <<Configuration of Server Device 10>>

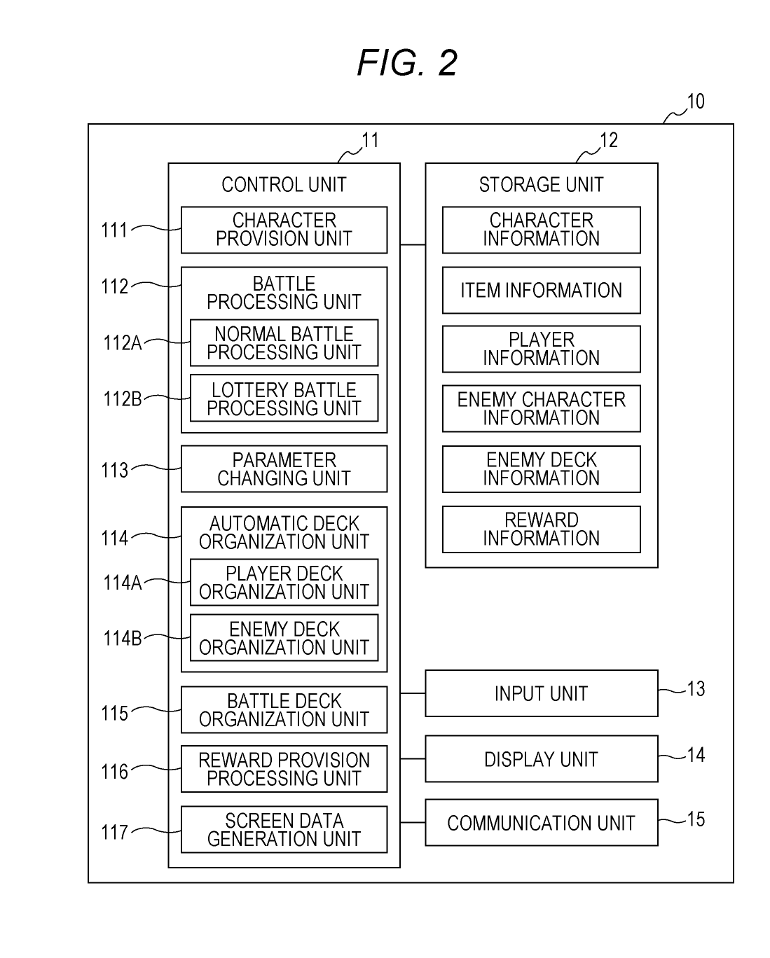

FIG. 2 is a block diagram illustrating a functional configuration of the server device 10 according to the present embodiment. The server device 10 is an information processing device (for example, a workstation, a personal computer, and the like) used when a system administrator and the like manage the game service. The server device 10 can distribute a game program operable on the player terminal 20, and a web page (game screen, and the like) made in a markup language (HTML, and the like) according to a specification of the player terminal 20 upon receiving various commands (requests) from the player terminal 20. The server device 10 includes a control unit 11, a storage unit 12, an input unit 13, a display unit 14, and a communication unit 15.

The control unit 11 performs data passing among units as well as controlling the entire server device 10, and is realized by a central processing unit (CPU) executing a program stored in a predetermined memory. The control unit 11 of the present embodiment includes a character provision unit 111, a battle processing unit 112, a parameter changing unit 113, an automatic deck organization unit 114, a battle deck organization unit 115, a reward provision processing unit 116, and a screen data generation unit 117.

The character provision unit 111 has the function of performing processing of providing a character to a player. The character provision unit 111 of the present embodiment, for example, provides a character selected from among a plurality of characters, in response to a character provision request from the player.

The battle processing unit 112 has the function of performing various types of processing related to a battle with an enemy character. The battle processing unit 112 includes a normal battle processing unit 112A and a lottery battle processing unit 112B. The normal battle processing unit 112A performs, in response to a battle request from a player terminal 20, processing of starting a normal battle game where battle is done with an enemy character which is set as an opponent, and determining the win or loss of the normal battle game. The lottery battle processing unit 112B performs processing of automatically starting a battle game with a lottery which is triggered by the provision of a character by the character provision unit 111 and where battle is done with an enemy character which is an opponent of the provided character, and determining the win or loss of the battle game with a lottery.

The parameter changing unit 113 has the function of performing processing of changing predetermined parameters set for a character and an enemy character. The parameter changing unit 113 of the present embodiment, for example, changes the hit point parameter of an enemy character, using the attack point parameter of a character provided by the character provision unit 111, during the progress of a battle game with a lottery performed by the lottery battle processing unit 112B.

The automatic deck organization unit 114 has the function of performing processing of organizing a deck composed of a plurality of characters, without based on an operation input from the player. The deck refers to a group of characters where a plurality of characters are put together in one set. The automatic deck organization unit 114 includes a player deck organization unit 114A and an enemy deck organization unit 114B. The player deck organization unit 114A has the function of automatically organizing a player deck composed of only characters provided by the character provision unit 111, independent of a player's operation. The enemy deck organization unit 114B has the function of organizing an enemy deck composed of a plurality of enemy characters.

The battle deck organization unit 115 has the function of performing processing of organizing a deck composed of a plurality of characters, based on an operation input from the player. The battle deck organization unit 115 of the present embodiment organizes a battle deck which is used in a normal battle game performed by the normal battle processing unit 112A.

The reward provision processing unit 116 has the function of performing processing of providing a reward to the player. The reward provision processing unit 116 of the present embodiment provides a reward to the player when the loss of an enemy character has been determined in a battle game with a lottery performed by the lottery battle processing unit 112B.

The screen data generation unit 117 has the function of performing processing of generating screen data for displaying a game screen on the player terminal 20. The screen data generation unit 117 of the present embodiment generates HTML data as the screen data corresponding to the game screen.

The storage unit 12 includes a read only memory (ROM) that is a read only storage area in which a system program is stored, and a random access memory (RAM) that is a rewritable storage area used as a work area for arithmetic processing by the control unit 11. The storage unit 12 is, for example, realized by a non-volatile storage device, such as a flash memory or a hard disk. The storage unit 12 of the present embodiment stores at least character information which is information about characters, item information which is information about game items, player information which is information about players, enemy character information which is information about enemy characters, enemy deck information about enemy decks, and reward information about rewards. Note that each of the information will be described in detail.

The input unit 13 is used by the system administrator and the like for inputting various data (for example, the character information and the like), and is realized by, for example, a keyboard, a mouse, and the like.

The display unit 14 is used for displaying an operation screen for the system administrator based on a command from the control unit 11, and is, for example, realized by a liquid crystal display (LCD) and the like.

The communication unit 15 is used for performing communication with the player terminal 20, and has a function as a reception unit that receives various data and signals transmitted from the player terminal 20, and a function as a transmission unit that transmits various data and signals to the player terminal 20 according to a command of the control unit 11. The communication unit 15 is, for example, realized by a network interface card (NIC), and the like.

### <<Configuration of Player Terminal 20>>

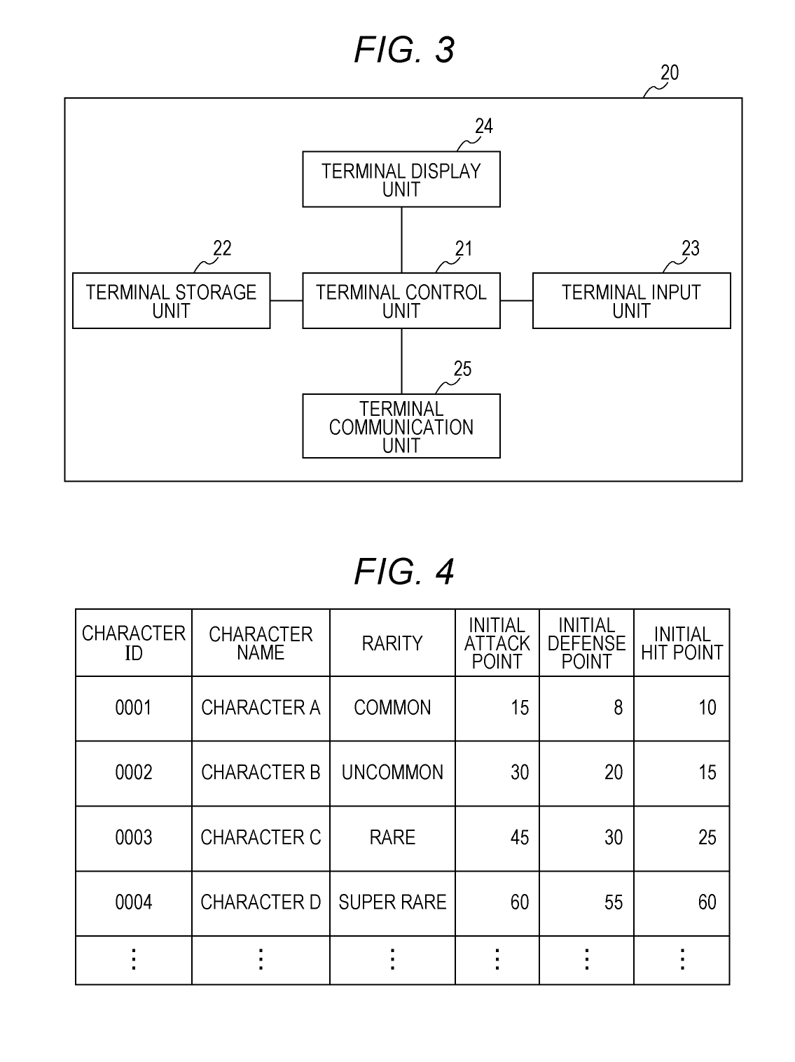

FIG. 3 is a block diagram illustrating a functional configuration of the player terminal 20. The player terminal 20 of the present embodiment is an information processing device (for example, a mobile phone terminal, a smart phone, a tablet-type terminal, and the like) used by the player when playing a game, and can request distribution of various types of information (a game program, a web page, and the like) related to the game to the server device 10. Since the player terminal 20 has a web browser function for allowing the player to browse a web page, the web page (a game screen, and the like) distributed from the server device 10 can be displayed on a screen. The player terminal 20 includes a terminal control unit 21, a terminal storage unit 22, a terminal input unit 23, a terminal display unit 24, and a terminal communication unit 25.

The terminal control unit 21 performs data passing among units and controls the entire player terminal 20, and is realized by the central processing unit (CPU) executing a program stored in a predetermined memory. Note that the terminal control unit 21 of the present embodiment also functions as a screen display control unit that controls a display form of the game screen displayed in the terminal display unit 24. The terminal storage unit 22 is connected to the terminal control unit 21 through a bus, and performs processing of referring to, reading out, rewriting stored data according to a command from the terminal control unit 21. The terminal storage unit 22 is realized, for example, by a flash memory, a hard disk, and the like. The terminal input unit 23 is used for performing various operations (a game operation, and the like) by the player, and is realized, for example, by an operation button, a touch panel, and the like. The terminal display unit 24 is used for displaying a game screen by a command from the terminal control unit 21, and is realized, for example, by a liquid crystal display (LCD) and the like. The terminal communication unit 25 functions as a transmission/reception unit for performing transmission/reception of various types of information with the server device 10 through the network 2, and is realized, for example, by a network interface card (NIC), and the like.

### <<Data Structure>>

FIG. 4 is a diagram illustrating an example of a data structure of the character information stored in the storage unit 12 of the server device 10. The character information includes items (fields) such as a character ID, a character name, rarity, initial attack point, initial defense point, and initial hit point. The character ID is identification information that identifies a character. The character name is information that indicates a display name of a character. The rarity is a parameter indicating the rarity level of the character. In the present embodiment, 4-level rarities are set for each character (“common”→“uncommon”→“rare”→“super rare”). The initial attack point, initial defense point, and initial hit point of the character are parameters indicating ability values which are initially set for the character. Note that the rarity is not limited to four levels. Note also that for the names of rarities, different names than those described above may be adopted.

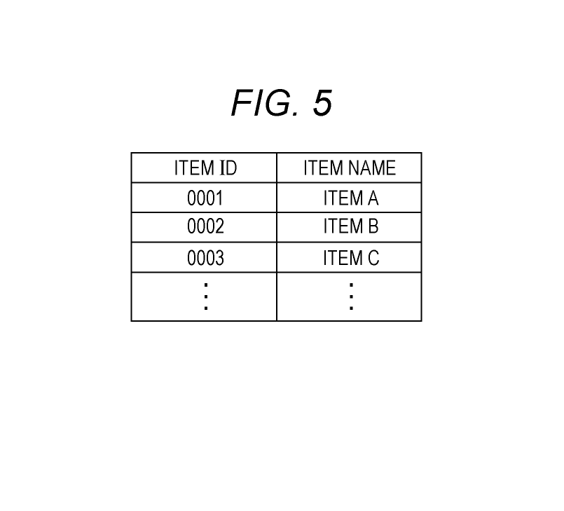

FIG. 5 is a diagram illustrating an example of a data structure of item information stored in the storage unit 12 of the server device 10. The item information includes items such as an item ID and an item name. The item ID is identification information that identifies an item. The item name is information indicating a display name of the item.

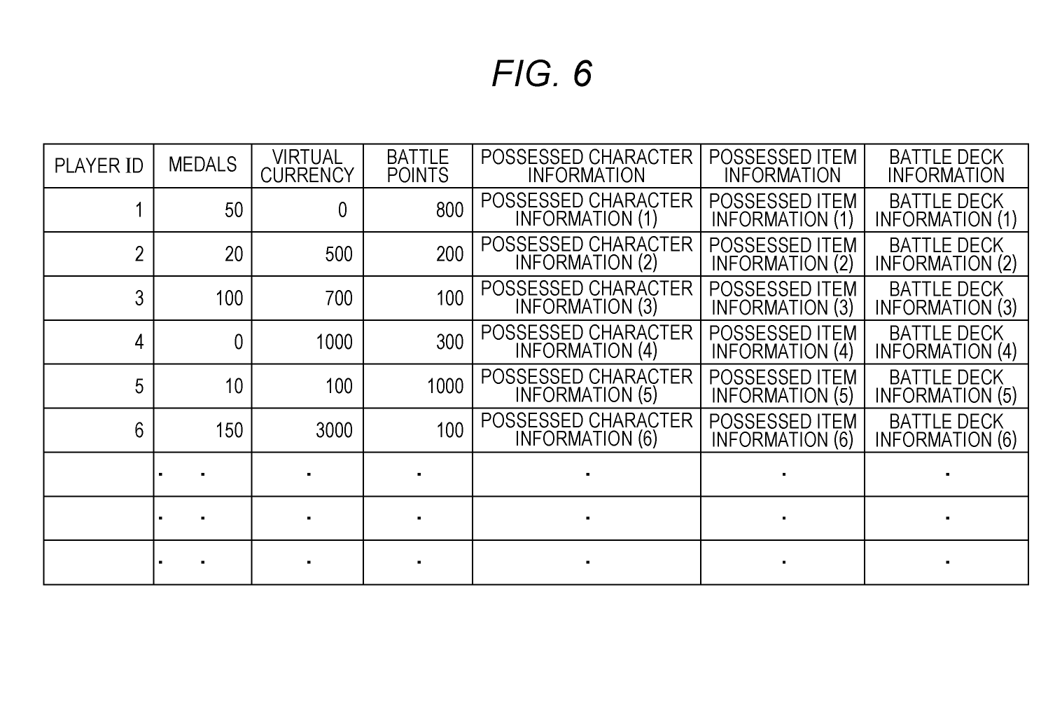

FIG. 6 is a diagram illustrating an example of a data structure of the player information stored in the storage unit 12 of the server device 10. The player information includes items such as a player ID, medals, virtual currency, battle points, possessed character information, possessed item information, and battle deck information. The player ID is identification information that identifies the player. The medals are an example of lottery points used in lottery games and are information indicating the amount of medals possessed by the player. The medals are a consumption parameter to be consumed upon playing a lottery game. The virtual currency is an example of play points and is information indicating the amount of virtual currency possessed by the player. The virtual currency is a consumption parameter to be consumed upon playing a battle game with a lottery. The battle points are information indicating the amount of battle points possessed by the player. The battle points are a consumption parameter to be consumed upon playing a normal battle game. The possessed character information is information indicating characters possessed by the player. The possessed item information is information indicating items possessed by the player. The battle deck information is information that defines a battle deck organized according to a player's operation.

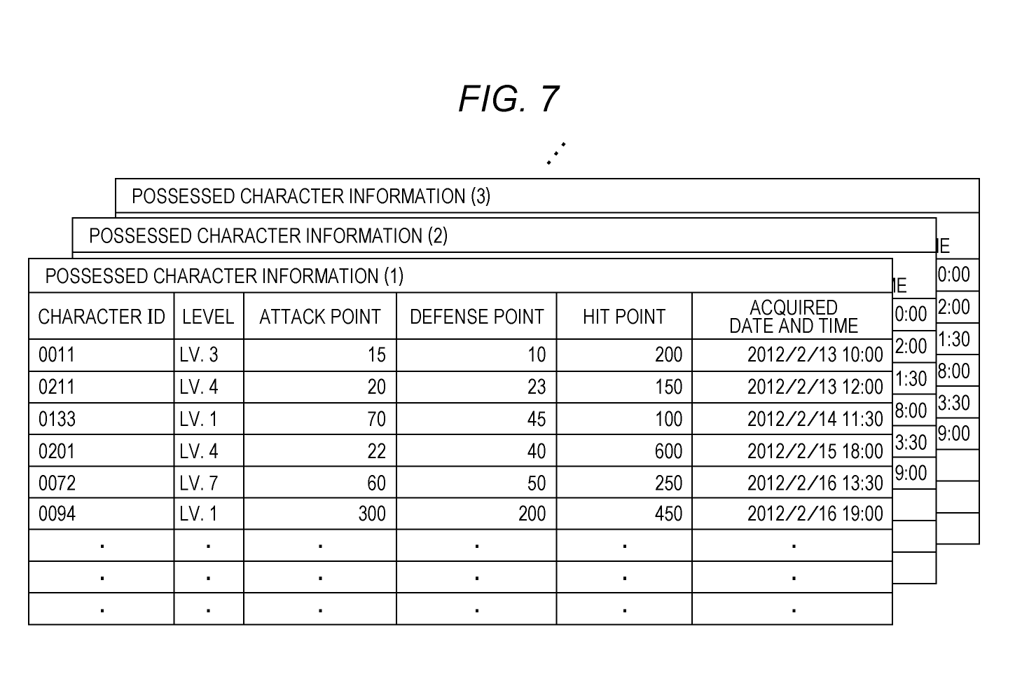

FIG. 7 is a diagram illustrating an example of a data structure of the possessed character information. The possessed character information includes items such as a character ID, the level of a character, attack point, defense point, hit point, and an acquired date and time. The character ID is identification information that identifies a character possessed by the player. The level, attack point, defense point, and hit point of the character are parameters indicating the current ability values set for the character possessed by the player. These various types of parameters are updated according to the progress of the game. The acquired date and time is information indicating the date and time when the player has acquired the character.

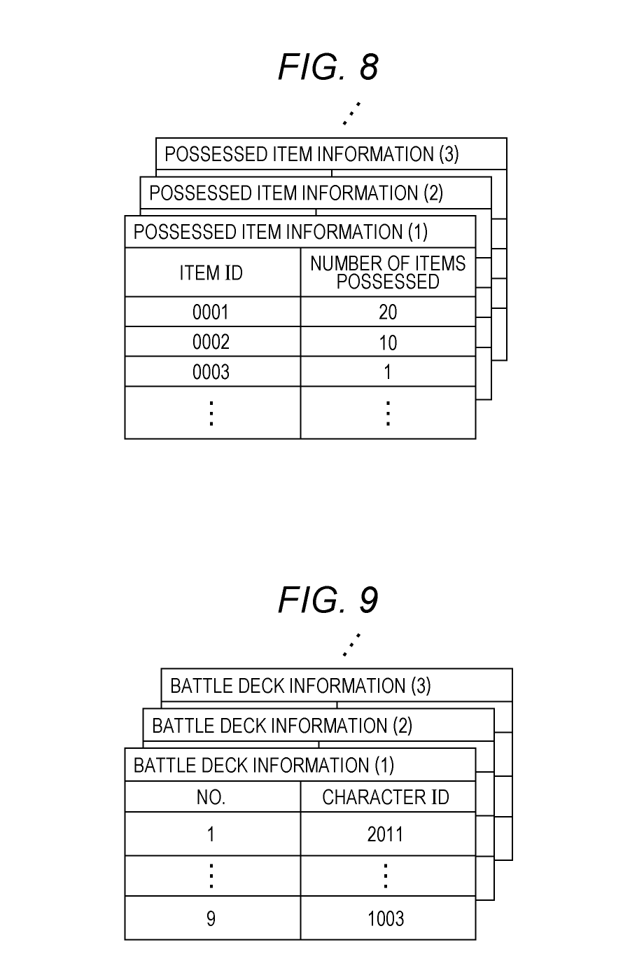

FIG. 8 is a diagram illustrating an example of a data structure of possessed item information. The possessed item information includes items such as an item ID and the number of items possessed. The item ID is identification information that identifies an item possessed by the player. The number of items possessed is information indicating the amount of items possessed by the player.

FIG. 9 is a diagram illustrating an example of a data structure of battle deck information. The battle deck information is information in which the character IDs of characters composing a battle deck are associated with serial numbers. A battle deck of the present embodiment is composed of nine characters in total which are assigned serial numbers 1 through 9.

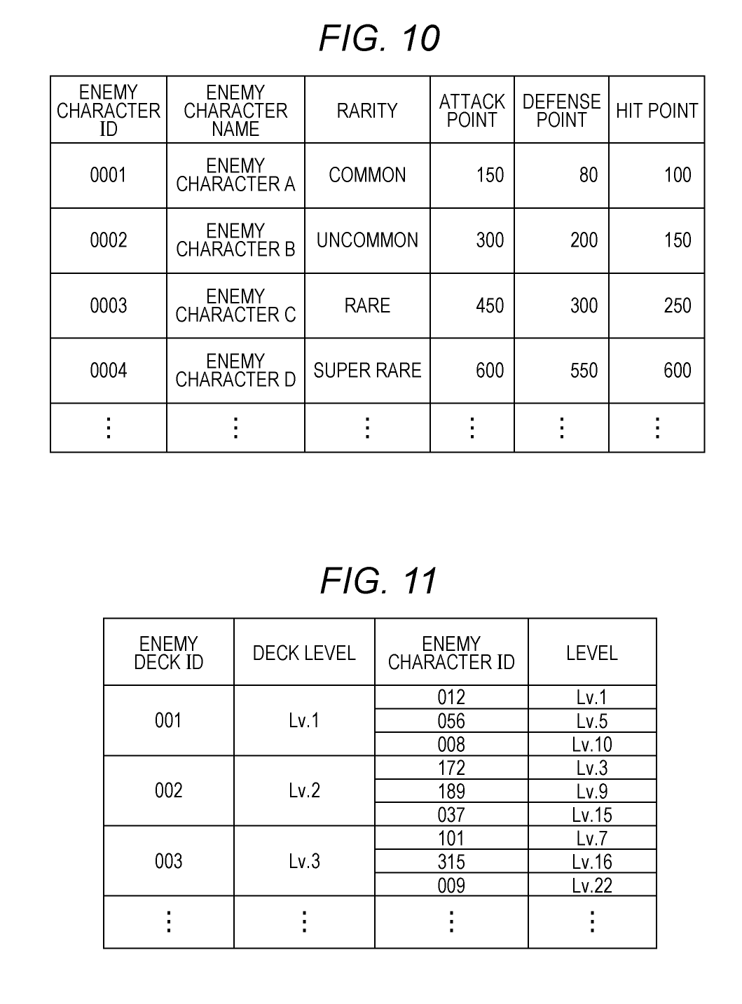

FIG. 10 is a diagram illustrating an example of a data structure of enemy character information. The enemy character information includes items (fields) such as an enemy character ID, an enemy character name, rarity, attack point, defense point, and hit point. The enemy character ID is identification information that identifies an enemy character which is an opponent. The enemy character name is information indicating a display name of the enemy character. The rarity is a parameter indicating the rarity level of the enemy character. In the present embodiment, 4-level rarities (“common”→“uncommon”→“rare”→“super rare”) are set for each enemy character. The attack point, defense point, and hit point of the enemy character are parameters indicating ability values set for the enemy character. Note that the rarity is not limited to four levels. Note also that for the names of rarities, different names than those described above may be adopted.

FIG. 11 is a diagram illustrating an example of a data structure of enemy deck information. The enemy deck information includes items (fields) such as an enemy deck ID, the level of an enemy deck, the character IDs of enemy characters composing the enemy deck, and the levels of the respective enemy characters. Each enemy deck of the present embodiment is composed of three enemy characters in total from among a plurality of enemy characters set in the enemy character information illustrated in FIG. 10. Different levels are set for the enemy characters composing one enemy deck.

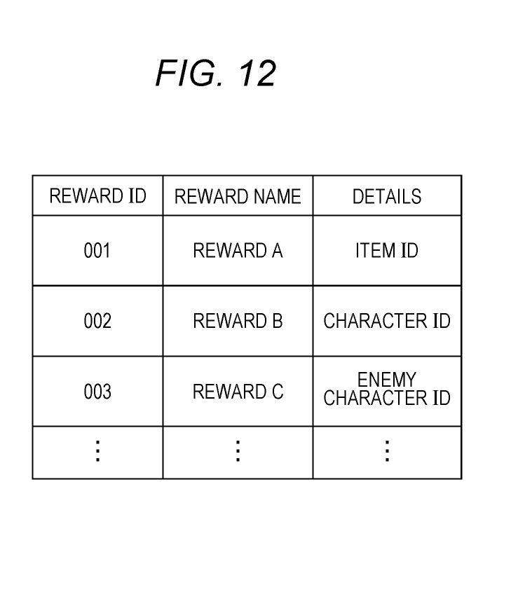

FIG. 12 is a diagram illustrating an example of a data structure of reward information. The reward information includes items such as a reward ID, a reward name, and details. For the details of a reward in the present embodiment, an item selected from the item information illustrated in FIG. 5, a character selected from the character information illustrated in FIG. 4, an enemy character selected from the enemy character information illustrated in FIG. 10, and the like, are set.

### <<Outline of Game>>

Here, an outline of a game provided by the game system 1 of the present embodiment will be described. The game system 1 provides various types of games which are played using electronic game cards (hereinafter, also called “characters”) associated with game characters.

### <Lottery Game>

In the game system 1 of the present embodiment, a player can play a lottery game, so-called “gacha gacha” (registered trademark), by consuming his/her medals (lottery points). In the lottery game, a character selected from among a plurality of characters is provided to the player.

Specifically, the character provision unit 111 reduces the amount of medals possessed by the player based on the player information illustrated in FIG. 6, and provides a character which is selected by a lottery from among a plurality of characters based on the character information illustrated in FIG. 4, to the player. Then, the character provision unit 111 updates corresponding possessed character information illustrated in FIG. 7 such that the provided character becomes a player's possessed character.

Note that the player can play a normal battle game which will be described later, using the character provided in the lottery game.

In the game system 1 of the present embodiment, the configuration is not limited thereto and the player may play a lottery game without consuming his/her medals (lottery points). In addition, in the game system 1, the player may play a lottery game by consuming his/her virtual currency (play points) and the like.

### <Normal Battle Game>

In the game system 1 of the present embodiment, the player can play a normal battle game where battle is done with an enemy character which is an opponent, by consuming his/her battle points.

Specifically, the normal battle processing unit 112A reduces the battle points possessed by the player, based on the player information illustrated in FIG. 6. Then, in response to a player's selection operation, the battle deck organization unit 115 selects a plurality of characters based on corresponding possessed character information illustrated in FIG. 7. The battle deck organization unit 115 organizes a battle deck composed of the plurality of characters selected according to the player's selection operation, and updates corresponding battle deck information illustrated in FIG. 9. Subsequently, the normal battle processing unit 112A selects an enemy character which becomes a player's opponent, by referring to the enemy character information illustrated in FIG. 10. At this time, the normal battle processing unit 112A can also select an enemy character according to a player's selection operation. Then, the normal battle processing unit 112A determines the win or loss of the normal battle game between the characters, based on various types of parameters (attack point, defense point, hit point, and the like) set for the respective characters composing the battle deck and various types of parameters (attack point, defense point, hit point, and the like) set for the enemy character, by referring to corresponding possessed character information illustrated in FIG. 7 and the enemy character information illustrated in FIG. 10.

Note that in the game system 1 of the present embodiment the configuration is not limited thereto and the player may play a normal battle game without consuming his/her battle points.

<Battle Game with Lottery>

In the game system 1 of the present embodiment, the player can play a battle game with a lottery by consuming his/her virtual currency (play points). In the battle game with a lottery, characters selected from among a plurality of characters are provided to the player, and the player does battle with an enemy character which is an opponent, using the provided characters as they are. Therefore, even if a character with low rarity is provided to the player, the character participates in a battle with its enemy character as it is, and thus, the character provided to the player can be actively used.

A battle game with a lottery of the present embodiment automatically starts triggered by the provision of characters to the player by a lottery, independent of a player's operation. Upon starting a battle with enemy characters, a player deck composed of only the provided characters is organized and an enemy deck composed of a plurality of enemy characters is organized. Thereafter, the win or loss of a battle game where each of the characters composing the player deck does battle with each of the enemy characters composing the enemy deck is determined. When, as a result of the battle, the loss of the enemy character has been determined, a reward is provided to the player.

Note that the player can also play the aforementioned normal battle game, using the characters provided in the battle game with a lottery.

Note also that in the game system 1 of the present embodiment the configuration is not limited thereto and the player may play a battle game with a lottery without consuming his/her virtual currency (play points).

In the following, an example of operation performed when the server device 10 and the player terminal 20 perform a battle game with a lottery in the game system 1 of the present embodiment will be specifically described.

### <<<Operation of Game System 1>>>

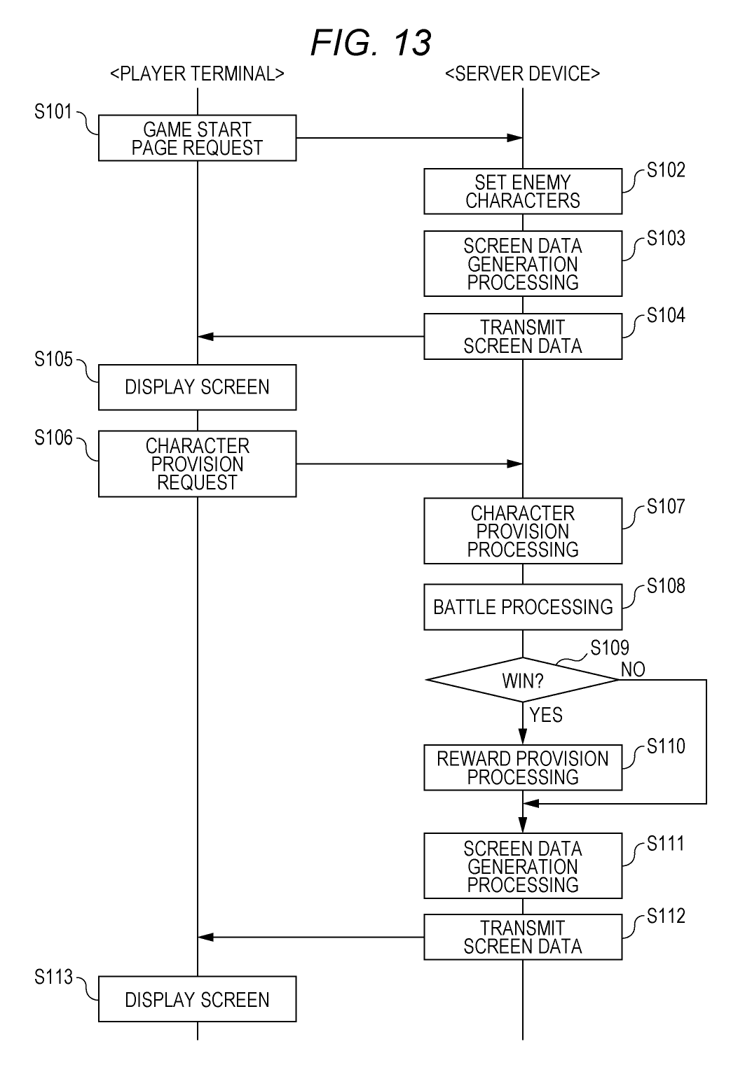

FIG. 13 is a flowchart for describing an example of the operation of the game system 1 according to the present embodiment.

First, in the player terminal 20, when the terminal control unit 21 receives a player's operation input from the terminal input unit 23, the terminal control unit 21 transmits a command for obtaining a game start page of a battle game with a lottery (game start page request) to the server device 10 through the terminal communication unit 25 (S101).

Subsequently, when the server device 10 accepts the game start page request transmitted from the player terminal 20, the server device 10 performs processing of setting enemy characters which are player's opponents (S102). In the present embodiment, as the player's opponents, an enemy deck composed of a plurality of enemy characters is set. Note that as the player's opponent, a single enemy character may be set.

Specifically, first, the enemy deck organization unit 114B organizes an enemy deck by combining enemy characters which are selected from among a plurality of enemy characters, based on the enemy character information illustrated in FIG. 10. Then, the enemy deck organization unit 114B updates the enemy deck information illustrated in FIG. 11, according to the enemy deck thus organized.

As illustrated in FIG. 11, the enemy deck is composed of three enemy characters, and the enemy characters have levels according to their strengths, and different values are set for the levels. In addition, the enemy deck itself is set with a deck level indicating total power.

Then, the enemy deck organization unit 114B selects an enemy deck serving as an opponent, from among a plurality of enemy decks by referring to the enemy deck information illustrated in FIG. 11. Here, upon selecting an enemy deck serving as an opponent, the enemy deck organization unit 114B of the present embodiment selects the enemy decks in turn starting with an enemy deck with the lowest deck level. That is, when a battle game with a lottery is repeatedly played, the deck level of the enemy deck gradually increases. Thus, as the player goes through more successive battles as a result of the player winning battle games with a lottery, the player does battle with more powerful enemy decks. Note that the configuration is not limited thereto, and an enemy deck may be randomly selected.

Subsequently, the server device 10 allows the screen data generation unit 117 to generate screen data (HTML file) for displaying a game start page (web page) of a battle game with a lottery on the player terminal 20 (S103).

The screen data generation unit 117 generates screen data of a game start page including information about the enemy characters composing the enemy deck, based on the enemy character information illustrated in FIG. 10 and the enemy deck information illustrated in FIG. 11.

Then, the server device 10 transmits the thus generated screen data (HTML file) for the game start page of a battle game with a lottery, to the player terminal 20 which is the request source through the network 2 (S104).

Subsequently, when the player terminal 20 receives the screen data (HTML file) transmitted from the server device 10, the player terminal 20 analyzes the screen data and thereby displays the game start page (web page) of a battle game with a lottery on the terminal display unit 24 (S105).

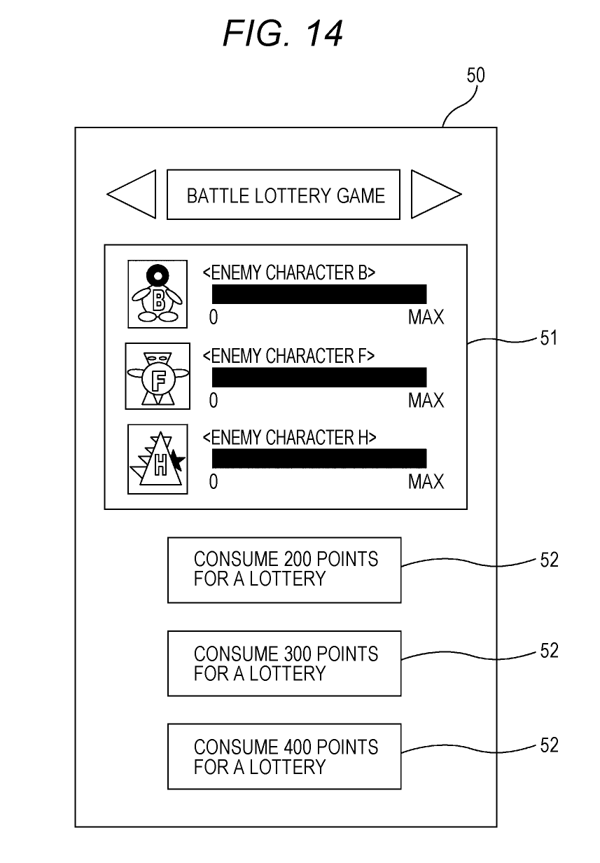

FIG. 14 is a diagram illustrating an example of a game start page 50 of a battle game with a lottery which is displayed on the terminal display unit 24. The game start page 50 includes an enemy deck display area 51 and operation buttons 52. Here, in the enemy deck display area 51, three enemy characters B, F, and H composing an enemy deck are arranged. The operation buttons 52 are buttons to be operated by the player when he/she wants to acquire characters by a lottery. Here, three types of operation buttons 52 are displayed according to the amount of virtual currency (play points) to be consumed.

Note that although here the three types of operation buttons 52 are displayed on the game start page 50, the operation buttons 52 are not limited thereto, and for example, one type of operation button 52 or five types of operation buttons 52 may be displayed.

Then, referring back to FIG. 13, when any one of the operation buttons 52 is selected by the player while the game start page 50 illustrated in FIG. 14 is displayed on the terminal display unit 24, the terminal control unit 21 of the player terminal 20 transmits, based on the operation information, a command requesting for provision of characters (character provision request) to the server device 10 through the terminal communication unit 25 (S106).

Then, when the server device 10 accepts the character provision request transmitted from the player terminal 20, the server device 10 performs character provision processing for determining characters to be provided to the player (S107).

Specifically, the character provision unit 111 reduces the amount of virtual currency possessed by the player, based on the player information illustrated in FIG. 6, and selects characters to be provided to the player by a lottery from among a plurality of characters, based on the character information illustrated in FIG. 4.

Note that at this time characters to be provided to the player may be selected by a lottery without consuming (reducing) virtual currency possessed by the player.

At this time, when a character selection is made by consuming 200-point virtual currency according to an operation input from the player, two characters are selected from among a plurality of characters. When 300-point virtual currency is consumed, three characters are selected from among a plurality of characters. When 400-point virtual currency is consumed, four characters are selected from among a plurality of characters. As such, as the amount of virtual currency consumed increases, the number of characters provided to the player increases.

When the character provision unit 111 thus determines the characters to be provided to the player, the character provision unit 111 updates corresponding possessed character information illustrated in FIG. 7 such that the provided characters become player's possessed characters.

Subsequently, the server device 10 automatically starts battle processing triggered by the provision of the characters to the player in the above-described character provision processing, independent of a player's operation (S108).

Specifically, first, the lottery battle processing unit 112B allows the player deck organization unit 114A to organize a player deck composed of only the characters provided to the player by the character provision unit 111. At this time, the player deck organization unit 114A automatically organizes a player deck according to the number of characters provided to the player by the character provision unit 111. Specifically, the player deck organization unit 114A can organize a more powerful deck with the larger number of characters provided to the player by the character provision unit 111. Subsequently, the lottery battle processing unit 112B performs processing of determining win or loss by allowing the player deck to do battle with the enemy deck. At this time, the lottery battle processing unit 112B allows the three enemy characters composing the enemy deck to do battle with the plurality of characters composing the player deck in turn, starting with an enemy character set with the lowest level (at this time, the order is not limited thereto and randomly selected enemy characters may be allowed to do battle in turn). Specifically, the parameter changing unit 113 calculates the magnitude of damage done to the first enemy character by each character in the player deck, based on the attack point parameters of the respective characters in the player deck and the defense point parameter of the first enemy character in the enemy deck, and reduces the hit point parameter of the first enemy character according to the magnitude of the damage. In addition, in the other way around, the parameter changing unit 113 calculates the magnitude of damage done to each character in the player deck by the first enemy character, based on the attack point parameter of the first enemy character and the defense point parameters of the respective characters in the player deck, and reduces the hit point parameters of the respective characters in the player deck according to the magnitude of the damage. When, as a result, the hit point parameter of the first enemy character is the first one to reach “0”, the lottery battle processing unit 112B determines the loss of the first enemy character. When the hit point parameters of all characters in the player deck are the first ones to reach “0”, the lottery battle processing unit 112B determines the loss of the player. Subsequently, when the loss of the first enemy character has been determined, the lottery battle processing unit 112B performs processing of determining the win or loss of a battle with the second enemy character in the enemy deck. In addition, likewise, when the loss of the second enemy character has been determined, the lottery battle processing unit 112B performs processing of determining the win or loss of a battle with the third enemy character in the enemy deck. Furthermore, when the loss of the third enemy character has been determined, the lottery battle processing unit 112B determines a full win of the player. Then, when a full win of the player has been determined, the lottery battle processing unit 112B performs setting to enable a battle with a next enemy deck set with a higher deck level than that of the enemy deck used this time. On the other hand, when the loss of the player has been determined, the lottery battle processing unit 112B performs setting to enable to rebattle with the enemy deck used this time, with the values of the hit point parameters of the remaining enemy characters in the enemy deck held. Note that at this time a rebattle may be done after resetting the values of the hit point parameters of the enemy characters.

Then, the server device 10 determines whether, as a result of performing such battle processing, the player has won against at least one enemy character among the plurality of enemy characters composing the enemy deck (S109). If the determination is affirmative (S109: YES), reward provision processing is performed (S110). Specifically, when the loss of the enemy character(s) has been determined, the reward provision processing unit 116 provides a reward(s) selected from among a plurality of rewards based on the reward information illustrated in FIG. 12, to the player. The reward provision processing unit 116 of the present embodiment selects one reward when the loss of one enemy character has been determined, and selects two rewards when the loss of two enemy characters has been determined, and provides the reward(s) to the player. Namely, in the battle game with a lottery, if the player can defeat three enemy characters at one battle, then the player can acquire three rewards at a time. Then, when the reward(s) is thus provided to the player, the reward provision processing unit 116 updates the player information illustrated in FIG. 6, according to the details of the provided reward(s).

On the other hand, if the determination is negative (S109: NO), processing proceeds to step S111. Specifically, when the characters provided to the player, the win or loss of the battle game, and the reward(s) provided to the player are determined by performing the character provision processing, the battle processing, and the reward provision processing, the server device 10 allows the screen data generation unit 117 to generate screen data of a game screen to be displayed on the player terminal 20 (S111). Then, the server device 10 transmits the screen data generated by the screen data generation unit 117 to the player terminal 20 which is the request source (S112).

Subsequently, when the player terminal 20 receives the screen data transmitted from the server device 10, the player terminal 20 analyzes the screen data and thereby displays a game screen on the terminal display unit 24 (S113). The player can check the result of the battle game with a lottery by viewing the game screen displayed on the terminal display unit 24.

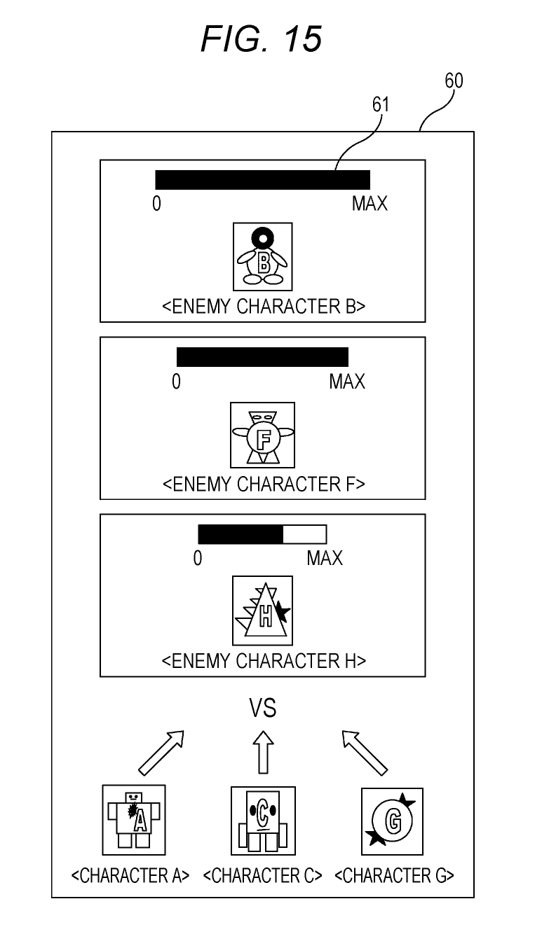

FIG. 15 is a diagram illustrating an example of a game screen 60 displayed on the terminal display unit 24 during the progress of the game. First, with the characters provided to the player (the characters selected by the character provision unit 111) displayed, the screen transitions to the game screen 60 for displaying the battle conditions with a special effect. Here, the screen displays a scene where a player deck composed of characters A, C, and G provided to the player is doing battle with an enemy deck composed of enemy characters B, F, and H. On the game screen 60 are displayed gauges 61 provided for the enemy characters B, F, and H, respectively. The length of the gauge 61 is set to the length corresponding to the magnitude of the hit point parameter of the enemy character.

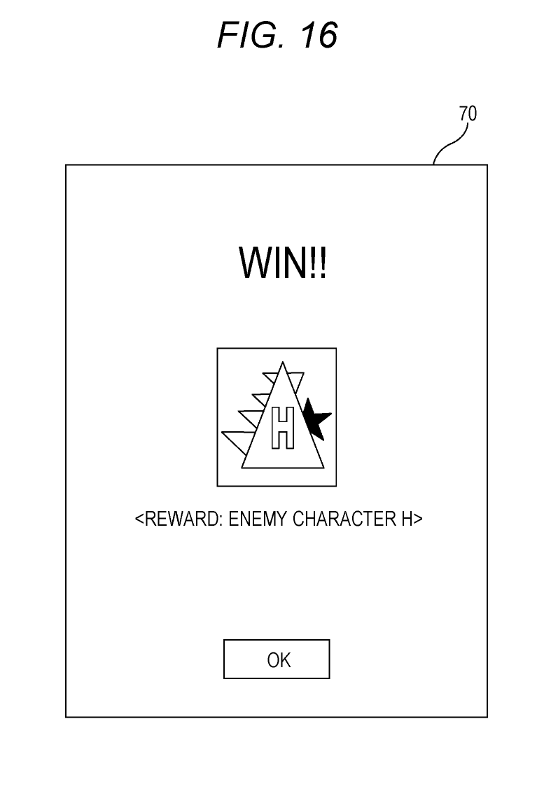

FIG. 16 is a diagram illustrating an example of a game screen 70 displayed on the terminal display unit 24 when the game is over. When the display with a special effect is finished on the game screen 60 illustrated in FIG. 15, the screen transitions to the game screen 70 for displaying a game result. Here, the screen displays that the player has won a battle with the first enemy character H (a game result determined by the lottery battle processing unit 112B) and that the first enemy character H (a reward selected by the reward provision processing unit 116) has been provided as it is as a reward.

As described above, according to the game system 1 according to the present embodiment, when characters are provided to the player by the character provision unit 111, battle processing with an enemy character which is an opponent automatically starts by the lottery battle processing unit 112B, triggered by the provision of the characters. Then, the win or loss of the battle with the enemy character is determined. Hence, a situation can be avoided where a character provided to the player is sold or combined and thus is not used at all in a battle with an enemy character. That is, when characters are provided to the player, a battle with an enemy character automatically starts. At the battle, the provided characters are used. Thus, the characters provided to the player can be actively used in battles with enemy characters.

### OTHER EMBODIMENTS

The above-described embodiments have been given for easy understanding of the present invention, and are not used to construe the present invention in a limited manner. The present invention can be changed and improved without departing from the gist of the invention and includes its equivalents. Especially, embodiments described below are also included in the present invention.

### <Providing of Character>

Although in the above-described embodiment the case has been exemplarily described in which when the character provision unit 111 makes a character selection by consuming 200-, 300-, 400-point virtual currency, the character provision unit 111 provides two, three, and four characters to the player, respectively, the present invention is not limited thereto. For example, by consuming 100-point virtual currency, one character may be provided to the player.

### <Change in Parameter>

Although in the above-described embodiment the case has been exemplarily described in which the parameter changing unit 113 changes the hit point parameter set for an enemy character, using the attack point parameters set for characters, the present invention is not limited thereto. For example, parameters such as rarity and level set for the characters may be used.

In addition, in the above-described embodiment, the parameter changing unit 113 may perform computation such that the lower the rarity of characters composing a player deck, the higher the damage done to enemy characters composing an enemy deck, and may reduce the hit point parameters of the enemy characters according to the magnitude of the damage.

### <Enemy Deck>

Although in the above-described embodiment the case has been exemplarily described in which the enemy deck organization unit 114B organizes an enemy deck composed of three enemy characters, the present invention is not limited thereto. For example, an enemy deck composed of one enemy character or an enemy deck composed of five enemy characters may be organized.

In addition, although in the above-described embodiment, as enemy characters which are player's opponents, an enemy deck composed of a plurality of enemy characters has been exemplarily described, the present invention is not limited thereto. For example, characters possessed by other players may be set as enemy characters which are player's opponents.

### <Server Device>

In the above-described present embodiments, the game system 1 provided with one server device 10 as an example of a server device has been exemplarily described. However, the game system 1 is not limited to this example, and may be provided with a plurality of server devices 10 as an example of the server device. That is, a plurality of server devices 10 is connected through a network 2, and each of the server devices 10 may perform various types of processing in a distributed manner. Note that the server device 10 is an example of a computer.

### <Information Processing Device>

In the above-described game system 1 in the present embodiments, a case has been exemplarily described, in which various types of information processing are executed based on a game program by the server device 10 and the player terminal 20 in cooperation with each other. However, the game system 1 is not limited to the example. The above-described various types of information processing may be executed by the player terminal 20 alone or by the server device 10 alone as an information processing device based on the game program.

Further, it may be configured such that the player terminal 20 bares a part of the functions as the information processing device. In this case, the server device 10 and the player terminal 20 constitute the information processing device.

Note that the information processing device is an example of a computer.

### <Game Program>

In the game system 1 of the above-described embodiment, the case has been exemplarily described in which various types of information processing are performed by allowing the server device 10 and the player terminal 20 to cooperate with each other. The present invention also includes a game program for performing such processing. Specifically, the server device 10 and the player terminal 20 which serve as information processing devices may perform the above-described processing, based on the game program.

FIG. 1
10 SERVER DEVICE
20 PLAYER TERMINAL

FIG. 2
11 CONTROL UNIT
111 CHARACTER PROVISION UNIT
112 BATTLE PROCESSING UNIT
112A NORMAL BATTLE PROCESSING UNIT
112B LOTTERY BATTLE PROCESSING UNIT
113 PARAMETER CHANGING UNIT
114 AUTOMATIC DECK ORGANIZATION UNIT
114A PLAYER DECK ORGANIZATION UNIT
114B ENEMY DECK ORGANIZATION UNIT
115 BATTLE DECK ORGANIZATION UNIT
116 REWARD PROVISION PROCESSING UNIT
117 SCREEN DATA GENERATION UNIT
12 STORAGE UNIT
CHARACTER INFORMATION
ITEM INFORMATION
PLAYER INFORMATION
ENEMY CHARACTER INFORMATION
ENEMY DECK INFORMATION
REWARD INFORMATION
13 INPUT UNIT
14 DISPLAY UNIT
15 COMMUNICATION UNIT

FIG. 3
21 TERMINAL CONTROL UNIT
22 TERMINAL STORAGE UNIT
23 TERMINAL INPUT UNIT
24 TERMINAL DISPLAY UNIT
25 TERMINAL COMMUNICATION UNIT

FIG. 4
CHARACTER ID
CHARACTER NAME
CHARACTER A
CHARACTER B
CHARACTER C
CHARACTER D
RARITY
COMMON
UNCOMMON
RARE
SUPER RARE
INITIAL ATTACK POINT
INITIAL DEFENSE POINT
INITIAL HIT POINT

FIG. 5
ITEM ID
ITEM NAME
ITEM A
ITEM B
ITEM C

FIG. 6
PLAYER ID
MEDALS
VIRTUAL CURRENCY
BATTLE POINTS
POSSESSED CHARACTER INFORMATION
POSSESSED ITEM INFORMATION
BATTLE DECK INFORMATION

FIG. 7
POSSESSED CHARACTER INFORMATION
CHARACTER ID
LEVEL
ATTACK POINT
DEFENSE POINT
HIT POINT
ACQUIRED DATE AND TIME

FIG. 8
POSSESSED ITEM INFORMATION
ITEM ID
NUMBER OF ITEMS POSSESSED

FIG. 9
BATTLE DECK INFORMATION
NO.
CHARACTER ID

FIG. 10
ENEMY CHARACTER ID
ENEMY CHARACTER NAME
ENEMY CHARACTER A
ENEMY CHARACTER B
ENEMY CHARACTER C
ENEMY CHARACTER D
RARITY
COMMON
UNCOMMON
RARE
SUPER RARE
ATTACK POINT
DEFENSE POINT
HIT POINT

FIG. 11
ENEMY DECK ID
DECK LEVEL
ENEMY CHARACTER ID
LEVEL

FIG. 12
REWARD ID
REWARD NAME
REWARD A
REWARD B
REWARD C
DETAILS
ITEM ID
CHARACTER ID
ENEMY CHARACTER ID

FIG. 13
PLAYER TERMINAL
SERVER DEVICE
S101 GAME START PAGE REQUEST
S102 SET ENEMY CHARACTERS
S103 SCREEN DATA GENERATION PROCESSING

S104 TRANSMIT SCREEN DATA
S105 DISPLAY SCREEN
S106 CHARACTER PROVISION REQUEST
S107 CHARACTER PROVISION PROCESSING
S108 BATTLE PROCESSING
S109 WIN?
S110 REWARD PROVISION PROCESSING
S111 SCREEN DATA GENERATION PROCESSING
S112 TRANSMIT SCREEN DATA
S113 DISPLAY SCREEN

FIG. 14
50 BATTLE LOTTERY GAME
ENEMY CHARACTER B
ENEMY CHARACTER F
ENEMY CHARACTER H
52 CONSUME 200 POINTS FOR A LOTTERY
52 CONSUME 300 POINTS FOR A LOTTERY
52 CONSUME 400 POINTS FOR A LOTTERY

FIG. 15
ENEMY CHARACTER B
ENEMY CHARACTER F
ENEMY CHARACTER H
CHARACTER A
CHARACTER C
CHARACTER G

FIG. 16
WIN!!
REWARD: ENEMY CHARACTER H

What is claimed is:

1. A non-transitory computer-readable storage medium that causes a computer to perform:
character provision processing of providing a character to a player, the character being selected, based on character information in which a plurality of characters are set, from among the plurality of characters;
battle processing of automatically starting a battle with an enemy character, triggered by the provision of the character, and determining win or loss of the battle, the enemy character being an opponent of the provided character; and
parameter change processing of changing a predetermined parameter set for the enemy character, using a predetermined parameter set for the provided character, during progress of the battle.

2. The non-transitory computer-readable storage medium according to claim 1, wherein
in the character provision processing,
at least two or more characters selected from among the plurality of characters based on the character information are provided to the player,
the game program causes the computer to perform:
player deck organization processing of automatically organizing a player deck independent of an operation of the player, upon starting the battle with the enemy character, the player deck composed of only the at least two or more provided characters, and
in the battle processing,
win or loss of a battle between each of the characters composing the organized player deck and the enemy character is determined.

3. The non-transitory computer-readable storage medium according to claim 2, wherein
the game program causes the computer to perform:
enemy deck organization processing of selecting, based on enemy character information in which a plurality of enemy characters are set, at least two or more enemy characters from among the plurality of enemy characters, and organizing an enemy deck composed of the at least two or more selected enemy characters, and
in the battle processing,
win or loss of a battle between each of the enemy characters composing the organized enemy deck and each of the characters composing the organized player deck is determined.

4. The non-transitory computer-readable storage medium according to any one of claims 1 to 3, wherein
the game program causes the computer to perform:
reward provision processing of providing a reward to the player when loss of the enemy character has been determined, the reward being selected, based on reward information in which a plurality of rewards are set, from among the plurality of rewards.

5. An information processing device comprising:
a character provision unit that provides a character to a player, the character being selected, based on character information in which a plurality of characters are set, from among the plurality of characters;
a battle processing unit that automatically starts a battle with an enemy character, triggered by the provision of the character, and determines win or loss of the battle, the enemy character being an opponent of the provided character; and
a parameter change processing unit that changes a predetermined parameter set for the enemy character, using a predetermined parameter set for the provided character, during progress of the battle.
